(19) United States
(12) Patent Application Publication
(10) Pub. No.: US 2012/0150594 A1
(43) Pub. Date: Jun. 14, 2012

(54) System and Method for Promoting Contests to Consumers via a Networked Application

(76) Inventor: Robert Snyder, Westerville, OH (US)

(21) Appl. No.: 12/964,223

(22) Filed: Dec. 9, 2010

(51) Int. Cl. G06Q 30/00

(52) U.S. Cl. 705/14.4

(57) ABSTRACT

A system and method includes a merchant database operable for maintaining merchant information including merchant contact information, contests associated with merchants, and prize information. A potential contest participant database is operable for maintaining participant information including participant contact information. A contest component is operable for conducting a scheduled contest for a merchant prize. A first selection component is operable for selecting a set of potential participants from the potential contest participant database to be notified of the scheduled contest, in which the selecting is at least, in part, based on location and past contest participation. A first notification component is operable for notifying the set of potential participants of the scheduled contest. A second selection component is operable for selecting the merchant prize from the merchant database. A network is included over which the databases and the components communicate where merchants can promote contests to consumers via a networked application.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to the field of computer supported networked application websites. More particularly, the invention relates to providing networked applications for contests.

### BACKGROUND OF THE INVENTION

Networked Internet contests, sweepstakes and give-away applications allow consumers to electronically enter skilled and non-skilled contests and drawings for a merchant. Contest applications allow merchants to post contests with prizes and set how many prizes are available. In general, the prize contests are constrained by time limit. Consumers may opt to enter in contests they are seeking to win, with a random consumer being determined as the winner of the contest. With this contest scenario, consumers typically only have access to contests for that specific merchant. Also, they are not notified of new contests and/or other offers and specials from the merchant. For example, a merchant may post a contest for a prize but, there is no notification of other merchant contests and/or other specials and offers.

In view of the foregoing, there is a need for improved techniques for providing networked contest applications and websites.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a block diagram depicting a conventional client/server communication system;

FIG. 2 presents a block diagram illustrating a system of operational portions and information flows between the operational portions, in accordance with an exemplary embodiment of the present invention;

FIGS. 3A-E present a flow chart illustrating an exemplary method for interaction with the elements of communication system presented in FIG. 1 and the system presented in FIG. 2, in accordance with an exemplary embodiment of the present invention; and

FIG. 4 illustrates a typical computer system that, when appropriately configured or designed, may serve as a computer system 400 for which the present invention may be embodied.

Unless otherwise indicated illustrations in the figures are not necessarily drawn to scale.

### SUMMARY OF THE INVENTION

To achieve the forgoing and other objects and in accordance with the purpose of the invention, a system and method for promoting contests to consumers via a networked application is presented.

In one embodiment a system includes means for maintaining merchant information including merchant contact information, contests associated with merchants, and prize information, means for maintaining participant information including participant contact information, means for maintaining contact information, means for conducting a scheduled contest for a merchant prize, means for selecting a set of potential participants from the potential contest participant database to be notified of the scheduled contest, means for notifying the set of potential participants of the scheduled contest, means for presenting additional merchant offers to potential participants, means for enabling a participant to invite others to participate in a contest, means for selecting the merchant prize from the merchant database, means for enabling a winner of the scheduled contest to invite one or more users to share in the merchant prize, means for maintaining survey data from participants, means for supporting third party contest components, third party contact databases, and third party notification components, and a network over which the system communicates where merchants can promote contests to consumers via a networked application.

In another embodiment a system includes a merchant database operable for maintaining merchant information including merchant contact information, contests associated with merchants, and prize information. A potential contest participant database is operable for maintaining participant information including participant contact information. A contest component is operable for conducting a scheduled contest for a merchant prize. A first selection component is operable for selecting a set of potential participants from the potential contest participant database to be notified of the scheduled contest, in which the selecting is at least, in part, based on location and past contest participation. A first notification component is operable for notifying the set of potential participants of the scheduled contest. A second selection component is operable for selecting the merchant prize from the merchant database for the scheduled contest. A network is included over which the databases and the components communicate where merchants can promote contests to consumers via a networked application. Another embodiment further includes a contact database operable for maintaining contact information including referring users. Yet another embodiment further includes a second notification component operable for enabling a winner of the scheduled contest to invite one or more users selected from the contact database and the potential contest participant database to share in the merchant prize. Still another embodiment further includes a third notification component operable for enabling a participant to invite others to participate in a contest. Another embodiment further includes a survey database operable for maintaining survey data from participants. Yet another embodiment further includes an additional offers component operable for presenting additional merchant offers to potential participants. Still another embodiment further includes means for supporting third party contest components, third party contact databases, and third party notification components in which the third party includes social networking systems. In another embodiment a winner of the scheduled contest is selected at random. In yet another embodiment the scheduled contest is conducted at regularly occurring times. In still another embodiment at least one notification component communicates with a mobile communications device.

In another embodiment a method includes steps of transmitting, over a network to a server, merchant information including merchant contact information, contests, and prize information. The merchant information is maintained in a merchant database. The method includes transmitting, over the network to a server, potential participant information including participant contact information. The potential participant information is maintained in a potential contest participant database. The method includes transmitting, over the network to a server, selection criteria where the selection criteria at least, in part, determines a set of potential participants from the potential contest participant database to be notified of a scheduled contest. The set of potential participants are notified of the scheduled contest. A contest component conducts the scheduled contest for a merchant prize and the merchant prize is selected from the merchant database, in which a merchant can promote contests to consumers via a networked application. Another embodiment further includes the step of transmitting, over the network to a server, contacts to be maintained in a contacts database where a winner of the scheduled contest can invite one or more users selected from the contact database and the potential contest participant database to share in the merchant prize. Yet another embodiment further includes the step of transmitting, over the network to a server, a limitation on a number of merchant prizes that can be shared. Still another embodiment further includes the step of transmitting, over the network to a server, offers to be presented to participants. Another embodiment further includes the step of receiving from a server survey data collected from participants. In yet another embodiment the scheduled contest is conducted at regularly occurring times. In still another embodiment a server communicates with a social networking system. In another embodiment a server communicates to a participant's mobile communication device. In yet another embodiment the set of potential participants are notified of multiple scheduled contests.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

A first embodiment of the present invention will be described which provides means and methods for enabling merchants to create and promote contests to consumers via a networked contest application. Prizes are offered by merchants to consumers, giving consumers incentive to view many merchants contests as well as other specials and merchant offers. Contests may be scheduled to be presented to potential participants at regularly scheduled and/or random days and times. Capabilities for adding new users may be provided. Non-limiting examples of new users which may be added include merchants, contacts and potential participants. Non-limiting examples of information provided by users for gaining access to the application include name, address, telephone number, credit card number, email address, user identification and password. Databases may be provided for storing, retrieving and maintaining contest related information. Non-limiting examples of information which may be stored in databases include information related to merchants, customers, potential customers, participants, contacts, contests, prizes, product offerings, special offers, additional offers, and contest notifications. Contests may be provided for merchants to incentivize potential consumers. A participant selection component may be provided for selecting potential participants for notification of an available contest. Non-limiting examples of criteria for selecting potential participants for notification include geographical region, previous date of contest entered, previous type or category of merchandise for a previously entered contest and previous type or category of merchant for a previously entered contest, or special offers printed, or viewed. A prize selection component may be provided for selecting random entries for each of the available prizes. Potential participants may be notified of available contests. Non-limiting examples of methods for communicating with potential participants include email, website, mail, telephone, mobile phone application and text message. Furthermore, capabilities may be provided for participants to invite others to participate in contests.

In other embodiments of the present invention, a method and means will be described for providing a capability for supporting third party contests, third party notifications and third party contact databases. Non-limiting examples of third party notification capabilities include third party email systems and social networking systems. Non-limiting examples of third party contact database includes third party email systems and third party social networks.

In other embodiments of the present invention, participants may offer to share a limited number of duplicate prizes won in the contest with other contacts and/or participants.

In other embodiments of the present invention, participants may offer to give items won in the contests to other contacts and/or participants.

In other embodiments of the present invention, merchants may operate to constrain contest notifications. Non-limiting examples of constraints merchants may place on contest notifications include number of prizes that are allowed to be shared, geographic location of participants, demographics of participants and other historical information.

In other embodiments of the present invention, notices of available contests may be presented to participants.

In other embodiments of the present invention, other offers may be provided in contest notices presented to participants. Non-limiting examples of other offers include accessories to prizes, coupons, product or service auctions and discounts.

In other embodiments of the present invention, a survey database may be provided for storing, retrieving and maintaining information retrieved from participants via surveys.

In other embodiments of the present invention, additional offers may be presented to potential participants. Non-limiting examples of additional offers include other products, services and special offers.

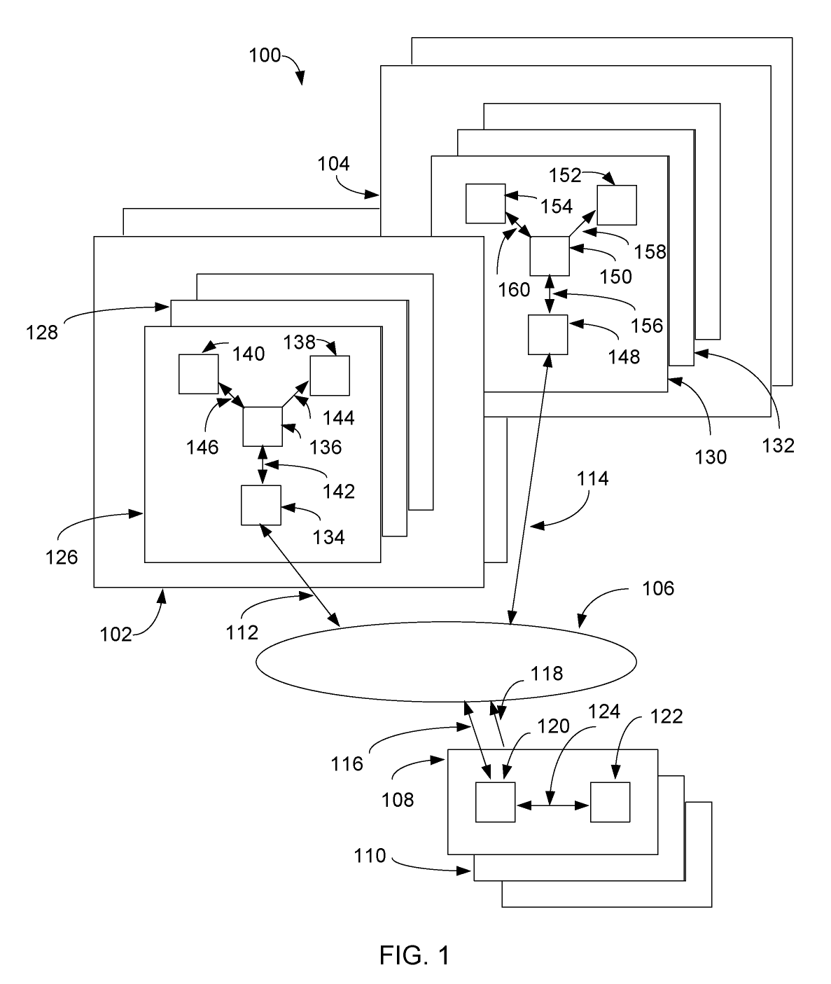

FIG. 1 illustrates a block diagram depicting a conventional client/server communication system.

A communication system 100 includes a multiplicity of networked regions with a sampling of regions denoted as a network region 102 and a network region 104, a global network 106 and a multiplicity of servers with a sampling of servers denoted as a server device 108 and a server device 110.

Network region 102 and network region 104 may operate to represent a network contained within a geographical area or region. Non-limiting examples of representations for the geographical areas for the networked regions may include postal zip codes, telephone area codes, states, counties, cities and countries. Elements within network region 102 and 104 may operate to communicate with external elements within other networked regions or within elements contained within the same network region.

In some implementations, global network 106 may operate as the Internet. It will be understood by those skilled in the art that communication systems 100 may take many different forms. Non-limiting examples of forms for communication system 100 include local area networks (LANs), wide area networks (WANs), wired telephone networks, cellular telephone networks or any other network supporting data communication between respective entities via hardwired or wireless communication networks. Global network 106 may operate to transfer information between the various networked elements.

Server device 108 and server device 110 may operate to execute software instructions, store information, support database operations and communicate with other networked elements. Non-limiting examples of software and scripting languages which may be executed on server device 108 and server device 110 include C, C++, C# and Java.

Network region 102 may operate to communicate bi-directionally with global network 106 via a communication channel 112. Network region 104 may operate to communicate bi-directionally with global network 106 via a communication channel 114. Server device 108 may operate to communicate bi-directionally with global network 106 via a communication channel 116. Server device 110 may operate to communicate bi-directionally with global network 106 via a communication channel 118. Network region 102 and 104, global network 106 and server devices 108 and 110 may operate to communicate with each other and with every other networked device located within communication system 100.

Server device 108 includes a networking device 120 and a server 122. Networking device 120 may operate to communicate bi-directionally with global network 106 via communication channel 116 and with server 122 via a communication channel 124. Server 122 may operate to execute software instructions and store information.

Network region 102 includes a multiplicity of clients with a sampling denoted as a client 126 and a client 128. Client 126 includes a networking device 134, a processor 136, a GUI 138 and an interface device 140. Non-limiting examples of devices for GUI 138 include monitors, televisions, cellular telephones, smartphones and PDAs (Personal Digital Assistants). Non-limiting examples of interface device 140 include pointing device, mouse, trackball, scanner and printer. Networking device 134 may communicate bi-directionally with global network 106 via communication channel 112 and with processor 136 via a communication channel 142. GUI 138 may receive information from processor 136 via a communication channel 144 for display to a user for viewing. Interface device 140 may operate to send control information to processor 136 and to receive information from processor 136 via a communication channel 146. Network region 104 includes a multiplicity of clients with a sampling denoted as a client 130 and a client 132. Client 130 includes a networking device 148, a processor 150, a GUI 152 and an interface device 154. Non-limiting examples of devices for GUI 138 include monitors, televisions, cellular telephones, smartphones and PDAs (Personal Digital Assistants). Non-limiting examples of interface device 140 include pointing devices, mousse, trackballs, scanners and printers. Networking device 148 may communicate bi-directionally with global network 106 via communication channel 114 and with processor 150 via a communication channel 156. GUI 152 may receive information from processor 150 via a communication channel 158 for display to a user for viewing. Interface device 154 may operate to send control information to processor 150 and to receive information from processor 150 via a communication channel 160.

For example, consider the case where a user interfacing with client 126 may want to execute a networked application. A user may enter the IP (Internet Protocol) address for the networked application using interface device 140. The IP address information may be communicated to processor 136 via communication channel 146. Processor 136 may then communicate the IP address information to networking device 134 via communication channel 142. Networking device 134 may then communicate the IP address information to global network 106 via communication channel 112. Global network 106 may then communicate the IP address information to networking device 120 of server device 108 via communication channel 116. Networking device 120 may then communicate the IP address information to server 122 via communication channel 124. Server 122 may receive the IP address information and after processing the IP address information may communicate return information to networking device 120 via communication channel 124. Networking device 120 may communicate the return information to global network 106 via communication channel 116. Global network 106 may communicate the return information to networking device 134 via communication channel 112. Networking device 134 may communicate the return information to processor 136 via communication channel 142. Processor 136 may communicate the return information to GUI 138 via communication channel 144. User may then view the return information on GUI 138.

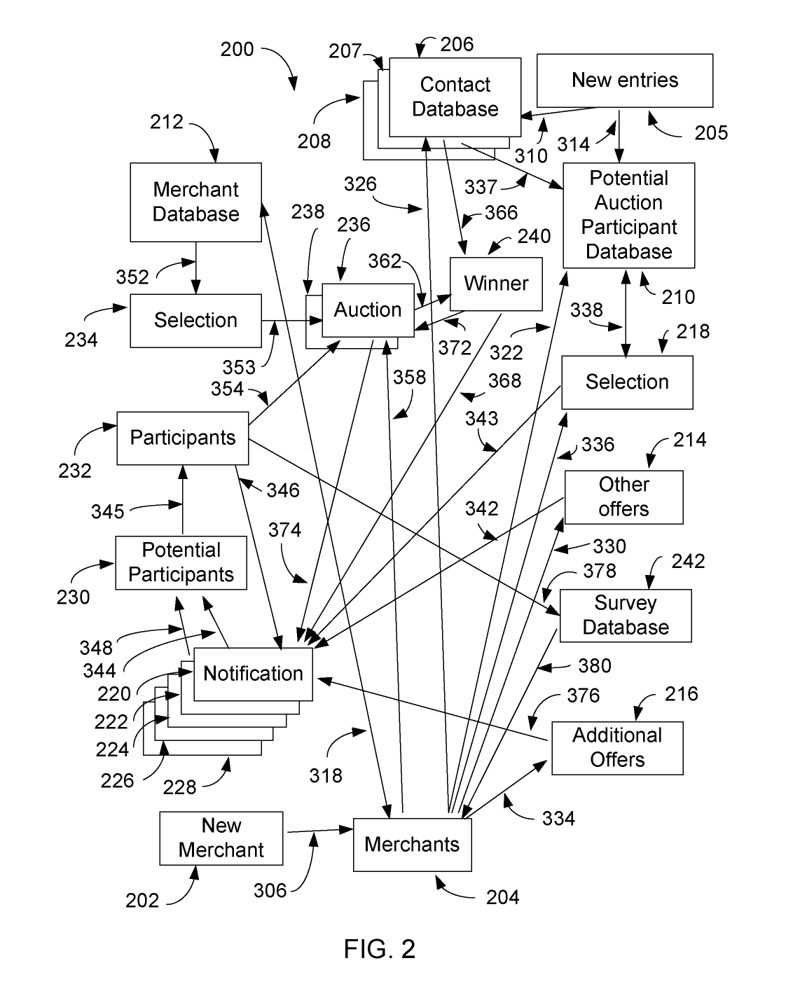

FIG. 2 presents a block diagram illustrating a system of operational portions and information flows between the operational portions, in accordance with an exemplary embodiment of the present invention.

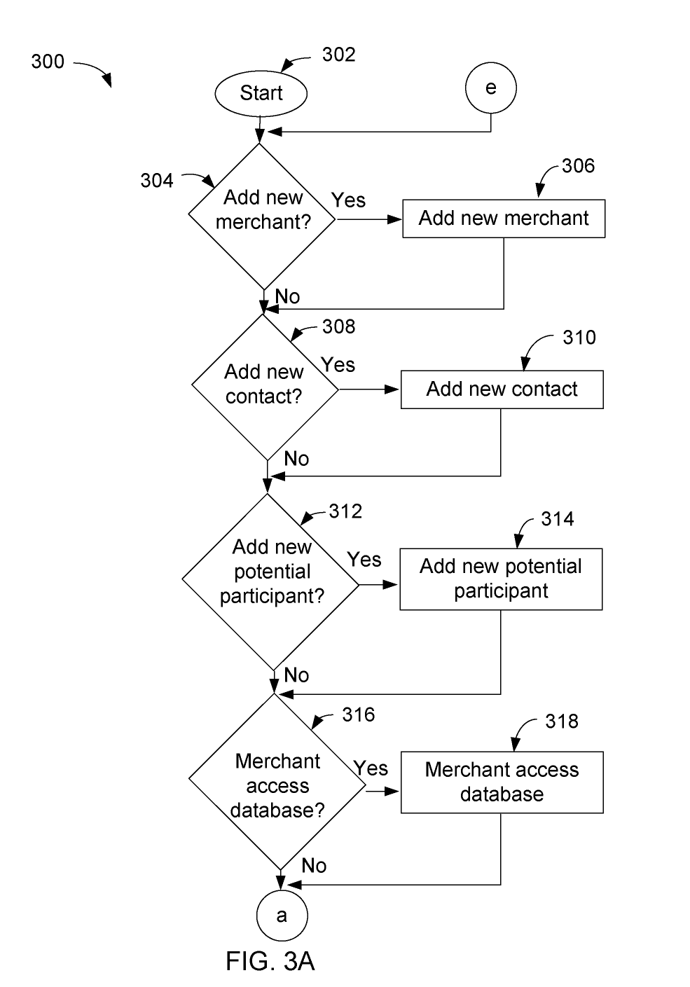

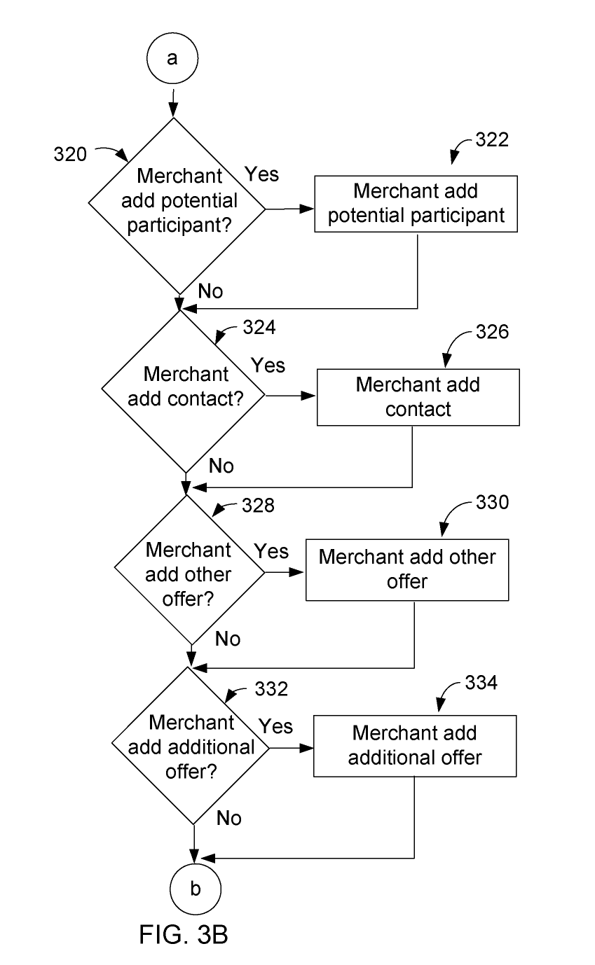

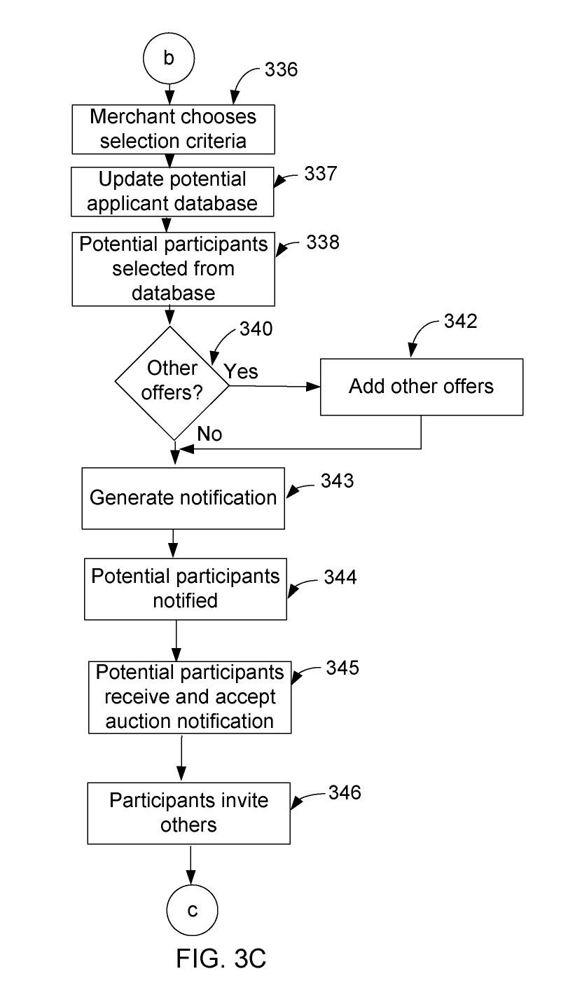

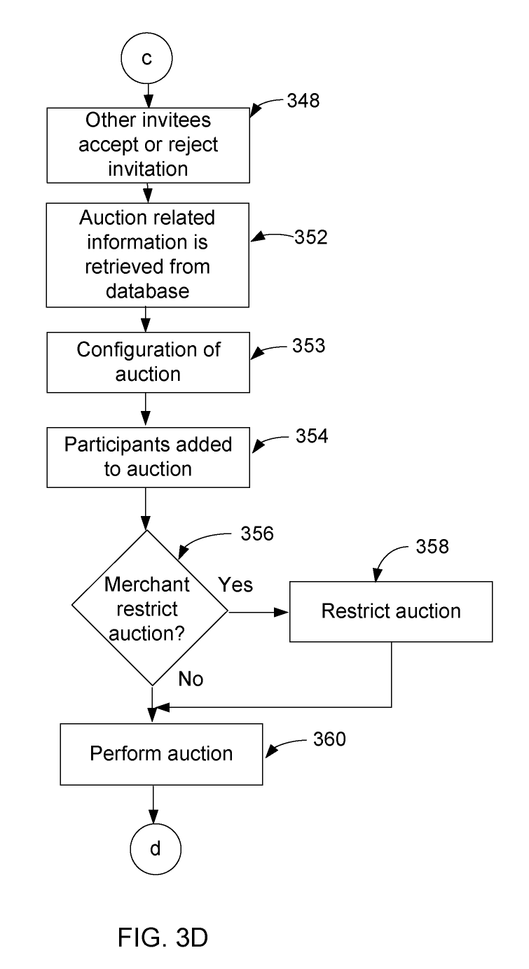

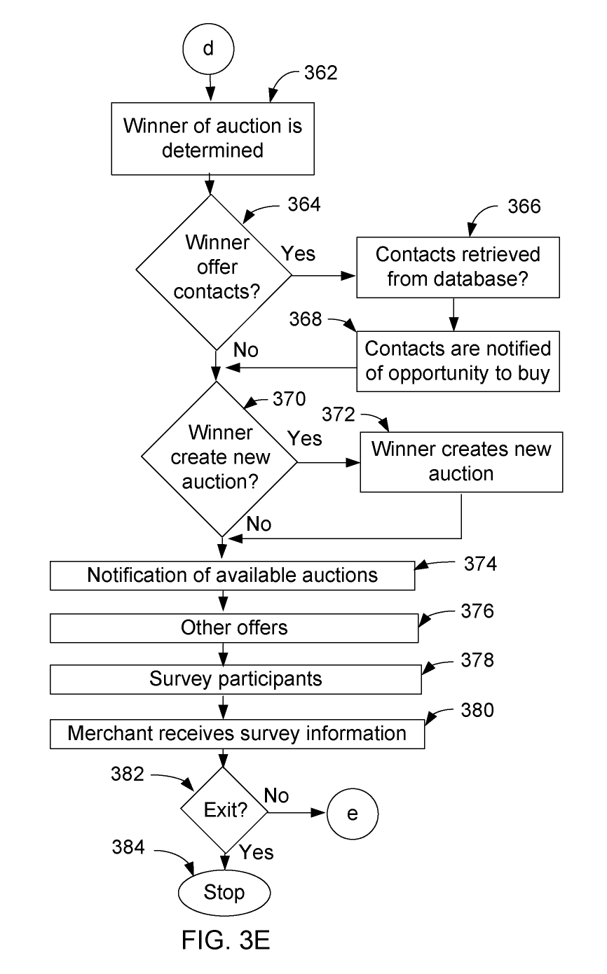

Information flows illustrated in FIG. 2 also correspond to operation of the flow chart illustrated in FIG. 3 which will be discussed in more detail in later paragraphs.

A system 200 includes a new merchant portion 202, a merchants portion 204, a new entries portion 205 a contact database portion 206, a third party contact database portion 207, a third party email contact database portion 208, a potential contest participant database portion 210, a merchant database portion 212, an other offers portion 214, an additional offers portion 216, a selection portion 218, a notification portion 220, an other participation notification portion 222, a winner notification portion 224, an available contests notification portion 226, an additional offers notification portion 228, a potential participants portion 230, a participants portion 232, a selection portion 234, an contest portion 236, a third party contest portion 238, a winner portion 240 and a survey database portion 242.

New merchant portion 202 may operate to add or include new merchants to system 200. Non-limiting examples of methods for contacting and adding new merchants via new merchant portion 202 include website, email, mail, phone, computer application and smartphone application. New entries portion 205 may operate to add or include new contacts, potential contacts or potential participants to system 200. Non-limiting examples of methods for contacting and adding new contacts via new entries portion 205 include website, email, mail, phone, computer application and smart-phone application. Contact database portion 206 may operate to store, retrieve and maintain information related to contacts. Non-limiting examples of information stored by contact database portion 206 for contacts include name, address, city, state, zip code, telephone number, email address, Internet home page, person referred by, initial contact point, credit card information, user identification, password and account preferences. Third party contact database portion 207 may operate to store, retrieve and maintain information related to third party contacts. Non-limiting examples of information stored by third party contact database portion 207 for contacts include name, address, city, state, zip code, telephone number, email address, Internet home page, person referred by, initial contact point, credit card information, user identification, password and account preferences. Third party email contact database portion 208 may operate to store, retrieve and maintain information related to third party email contacts. Non-limiting examples of information stored by third party email contact database portion 208 for contacts include name, address, city, state, zip code, telephone number, email address, Internet home page, person referred by, initial contact point, credit card information, user identification, password and account preferences. Potential contest participant database portion 210 may operate to store, retrieve and maintain information related to potential participants. Non-limiting examples of information stored by potential contest participant database portion 210 for potential contest participants include name, address, city, state, zip code, telephone number, email address, Internet home page, person referred by, initial contact point, credit card information, user identification, password and account preferences. Merchant database portion 212 may operate to store, retrieve and maintain information related to merchants and contests. Non-limiting examples of information stored by merchant database portion 212 include prizes, prize information, previous contests, current contests, date of contests, time of contests, company name, proprietor name, address, city, state, zip code, telephone number, email address, Internet home page, entity referred by, initial contact point, account preferences, tax identification information, user identification, password and credit card information. Other offers portion 214 may operate to make special offers to potential participants, participants and contacts. Non-limiting examples of other offers include offers from other vendors, product bundling offers, coupons and friend referral offers. Additional offers portion 216 may operate to provide additional offers to contest notifications for potential participants. Non-limiting examples of additional offers include offers from other vendors, product bundling offers, coupons and friend referral offers. Selection portion 218 may operate to select potential participants from potential contest participant database portion 210 for contest notifications. Non-limiting examples of criteria used by selection portion 218 for making selection include geographic area, date of last entry made, previous merchant prize category entry and previous merchant category for contest win. Notification portion 220 may operate to notify potential participants of the availability of a contest. Non-limiting examples of information provided by notification portion 220 to potential participants include prize, day of contest, time of contest, link for registering for contest and link for entering contest. Winner notification portion 224 may operate to allow a winner of a contest the ability to share a limited number of duplicate prizes received from the contest to other contacts. Non-limiting examples of information provided by winner notification portion 224 to other contacts include prize, prize information, day of contest, time of contest, link for registering for contest Available contests notification portion 226 may operate to notify contacts, participants and potential participants of contests available for participating. Non-limiting examples of information provided by available contests notification portion 226 to potential participants include prize information, day of contest, time of contest, and a link for registering for the contest. Additional offers notification portion 228 may operate to notify contacts, participants and potential participants of additional offers. Non-limiting examples of additional offers that may be provided include accessories to prizes, auctions, coupons, bundling offers, special offers and friend referral offers. Potential participants portion 230 may operate to determine conversions to participants. Participants portion 232 may operate to assign participants with contests participants are seeking to participate. Selection portion 234 may operate to retrieve information related to contests from merchant database portion 212. Non-limiting examples of information retrieved from merchant database portion 212 by selection portion 234 includes prizes, prize information, day of contest, time of contest, link for registering for contest and link for entering contest. Contest portion 236 may operate to perform contests of prizes provided to participants for Entering. Third party contest portion 238 may operate to perform contests of prizes provided to participants for entering from a third party contest entity. Winner portion 240 may operate to manage interaction with a winner of a contest. Survey database portion 242 may operate to store, retrieve and maintain information received from or about contacts, participants and potential participants related to surveys. Non-limiting examples of information stored by survey database portion 242 includes answers to surveys, questions on surveys, products purchased, contests participated in, name, address, city, state, zip code, telephone number, email address, Internet home page, person referred by, initial contact point and credit card information.

Selection portion 234 may operate to select a merchant contest offer from information stored in merchant database portion 212. Non-limiting examples of criteria selection portion 234 may use for making contest selection include merchant category, number and type of prizes offered, and number of entries so far.

A unidirectional flow of information may be received by merchants portion 204 from new merchant portion 202 via a step 306. A unidirectional flow of information may be received by contact database portion 206 from new entries portion 205 via a step 310. A unidirectional flow of information may be received by potential contest participant database portion 210 from new entries portion 205 via a step 314. Merchants portion 204 may communicate bi-directionally with merchant database portion 212 via a step 318. A unidirectional flow of information may be received by potential contest participant database portion 210 from merchants portion 204 via a step 322. A unidirectional flow of information may be received by contact database portion 206 from merchants portion 204 via a step 326. A unidirectional flow of information may be received from other offers portion 214 from merchants portion 204 via a step 330. A unidirectional flow of information may be received by additional offers portion 216 from merchants portion 204 via a step 334. A unidirectional flow of information may be received by selection portion 218 from merchants portion 204 via a step 336. A unidirectional flow of information may be received by potential contest participant database portion 210 from contact database portion 206, third party contact database portion 207 and third party email contact database portion 208. Selection portion 218 may communicate bi-directionally with potential contest participant database portion 210 via a step 338. A unidirectional flow of information may be received by notification portion 220 from other offers portion 214 via a step 342. A unidirectional flow of information may be received by notification portion 220 from selection portion 218 via a step 343. A unidirectional flow of information may be received by potential participants portion 230 from notification portion 220 via a step 344. A unidirectional flow of information may be received from potential participants portion 230 via a step 345. A unidirectional flow of information may be received by other participation notification portion 222 from participants portion 232 via a step 346. A unidirectional flow of information may be received by potential participants portion 230 from other participation notification portion 222 via a step 348. A unidirectional flow of information may be received by selection portion 234 from merchant database portion 212 via a step 352. A unidirectional flow of information may be received by contest portion 236 and third party contest portion 238 from selection portion 234 via a step 353. A unidirectional flow of information may be received by contest portion 236 and third party contest portion 238 from participants portion 232 via a step 354. A unidirectional flow of information may be received by contest portion 236 and third party contest portion 238 from merchants portion 204 via a step 358. A unidirectional flow of information may be received by winner portion 240 from contest portion 236 and from third party contest portion 238 via a step 362. A unidirectional flow of information may be received by winner portion 240 from contact database portion 206, third party contact database portion 207 and third party email contact database portion 208 via a step 366. A unidirectional flow of information may be received by winner notification portion 224 from winner portion 240 via a step 368. A unidirectional flow of information may be received by contest portion 236 and by third party contest portion 236 via a step 372. A unidirectional flow of information may be received by available contest notification portion 226 from contest portion 236 and third party contest portion 238 via a step 374. A unidirectional flow of information may be received by additional offers notification portion 228 from additional offers portion 216 via a step 376. A unidirectional flow of information may be received by survey database portion 242 from participants portion 232 via a step 378. A unidirectional flow of information may be received by merchants portion 204 from survey database portion 242 via a step 380.

FIGS. 3A-E present a flow chart illustrating an exemplary method 300 for interaction with the elements of communication system 100 (FIG. 1) and system 200 (FIG. 2), in accordance with an exemplary embodiment of the present invention.

For the present exemplary embodiment, the process initiates in a step S302 (FIG. 3A). In a step 304, it may be determined whether a new merchant may be added. For a determination to add a new merchant in step 304, a new merchant may be added in step 306 (FIG. 2,3A). For addition of a new merchant, merchant may interface via GUI 138 (FIG. 1) with information received from merchant via GUI 138 (FIG. 1) being communicated via communication channel 144 (FIG. 1), processor 136 (FIG. 1), communication channel 142 (FIG. 1), networking device 134 (FIG. 1), communication channel 112 (FIG. 1), global network 106 (FIG. 1), communication channel 116 (FIG. 1), networking device 120 (FIG. 1) and communication channel 124 (FIG. 1) to server 122 (FIG. 1). Furthermore, information received from merchant via GUI 138 (FIG. 1) may be stored in merchant database portion 212 (FIG. 2) with database portion 212 (FIG. 2) resident in server 122 (FIG. 1). In a step 308, it may be determined whether a new contact may be added. For a determination to add a new contact in step 308, a new contact may be added in step 310 (FIG. 2,3A). In a step 312, it may be determined whether a new potential participant may be added. For a determination to add a new potential participant in step 312, a new potential participant may be added in step 314 (FIG. 2,3A). In a step 316, it may be determined if a merchant may access merchant database portion 212 (FIG. 2). For a determination of merchant accessing merchant database portion 212 (FIG. 2), merchant may access merchant database portion 212 (FIG. 2) in step 318 (FIG. 2,3A). In a step 320 (FIG. 2B), it may be determined if a merchant may add a potential participant to potential contest participant database portion 210 (FIG. 2). For a determination of merchant adding a potential participant to potential contest participant database portion 210 (FIG. 2), merchant may add potential participant to potential contest participant database portion 210 (FIG. 2) in step 322 (FIG. 2,3B). In a step 324, it may be determined whether a merchant may add a new contact to the contact database portion 206 (FIG. 2). For a determination of merchant adding a new contact to the contact database portion 206 (FIG. 2) in step 324, merchant may add a new contact to contact database portion 206 (FIG. 2) in step 326 (FIG. 2,3B). In a step 328, it may be determined whether a merchant may add other offer to other offers portion 214 (FIG. 2). For a determination of merchant adding an offer in step 328, in step 330 (FIG. 2,3B), merchant may add other offer to other offers portion 214 (FIG. 2). In a step 332, it may be determined whether merchant may add an additional offer. For a determination of merchant adding an additional offer in step 332, merchant may add an additional offer in step 334 (FIG. 2,3B). In step 336 (FIG. 2,3C), merchant may choose selection criteria for potential contest participants. In a step 337 (FIG. 2,3C), potential contest participant database portion 210 (FIG. 2) may be updated with contact information from contact database portion 206 (FIG. 2), third party contact database portion 207 (FIG. 2) and third party email contact database portion 208 (FIG. 2). In step 338 (FIG. 2,3C), potential participants may be selected from potential contest participant database portion 210 (FIG. 2). In a step 340, it may be determined whether other offers may be presented to potential contest participants. For a determination of making other offers in step 340, other offers may be included in potential participant notifications in step 342 (FIG. 2,3C). In step 343 (FIG. 2,3C), a notice of a contest may be generated for potential contest participants. In step 344 (FIG. 2,3C), a notice of a contest may be delivered to potential contest participants. In step 345 (FIG. 2,3C), potential contest participants may receive and accept notice of a contest. In step 346 (FIG. 2,3C), contest participants may invite others to join in the contest. In step 348 (FIG. 2,3D), other invitees accept or reject contest invitation. In step 352 (FIG. 2,3D), contest related information might be retrieved from merchant database portion 212. In step 353 (FIG. 2,3D), configuration of contest may be performed. In step 354 (FIG. 2,3D), participants may be added to contest. In a step 356, it may be determined if a merchant seeks to limit or constrain participants of the contest. For a determination of merchant opting to restrict participants in step 356, merchant may restrict participants of the contest in step 358 (FIG. 2,3D). In a step 360 (FIG. 2,3D), contest may be performed. In step 362 (FIG. 2,3E), a winner of contest may be determined. It may be determined in a step 364 if winner opts to offer to sell purchase product to other contacts. For a determination of winner opting to sell purchased product in step 364, contacts may be retrieved from contact database portion 206 (FIG. 2), third party contact database portion 207 (FIG. 2) and/or third party email contact database portion 208 (FIG. 2) in step 366 (FIG. 2,3E). In step 368 (FIG. 2,3E), contacts may be notified of opportunity to receive a prize that was won by winner in the contest. It may be determined in a step 370 if winner opts to share the prize. For a determination of winner opting to share a limited number of duplicates of the prize won in the contest in step 370, winner may share the duplicate of the prize in step 372 (FIG. 2,3E). In step 374 (FIG. 2,3E), participants may be notified of prizes available for the participants to receive. In step 376 (FIG. 2,3E), participants may be notified of other offers available for participants. In step 378 (FIG. 2,3E), participants may receive surveys with results stored, accessed and maintained in survey database portion 242 (FIG. 2). In step 380 (FIG. 2,3E), merchant may receive or query survey information obtained from participants. It may be determined in a step 382 whether operation of process continues. For a determination of continuing the process, execution of process transitions to step 304 (FIG. 3A). For a determination of not continuing the process, execution of process transitions to a step 384 and ceases operation.

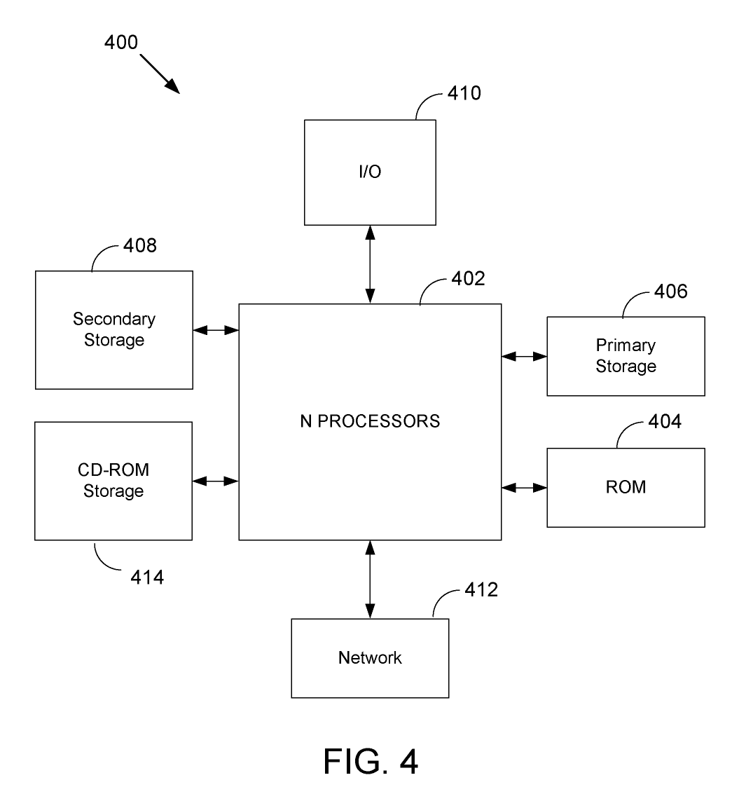

FIG. 4 illustrates a typical computer system that, when appropriately configured or designed, may serve as a computer system 400 for which the present invention may be embodied.

Computer system 400 includes a quantity of processors 402 (also referred to as central processing units, or CPUs) that may be coupled to storage devices including a primary storage 406 (typically a random access memory, or RAM), a primary storage 404 (typically a read only memory, or ROM). CPU 402 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 404 acts to transfer data and instructions uni-directionally to the CPU and primary storage 406 typically may be used to transfer data and instructions in a bi-directional manner. The primary storage devices discussed previously may include any suitable computer-readable media such as those described above. A mass storage device 408 may also be coupled bi-directionally to CPU 402 and provides additional data storage capacity and may include any of the computer-readable media described above. Mass storage device 408 may be used to store programs, data and the like and typically may be used as a secondary storage medium such as a hard disk. It will be appreciated that the information retained within mass storage device 408, may, in appropriate cases, be incorporated in standard fashion as part of primary storage 406 as virtual memory. A specific mass storage device such as a CD-ROM 414 may also pass data uni-directionally to the CPU.

CPU 402 may also be coupled to an interface 410 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 402 optionally may be coupled to an external device such as a database or a computer or telecommunications or internet network using an external connection shown generally as a network 412, which may be implemented as a hardwired or wireless communications link using suitable conventional technologies. With such a connection, the CPU might receive information from the network, or might output information to the network in the course of performing the method steps described in the teachings of the present invention.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived there from.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: server devices 108 and 110 and global network 106 as illustrated in FIG. 1 and the operation of the example embodiment as illustrated in FIG. 2 and FIGS. 3A-E.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

Having fully described at least one embodiment of the present invention, other equivalent or alternative methods of providing networked contest applications according to the present invention will be apparent to those skilled in the art. The invention has been described above by way of illustration, and the specific embodiments disclosed are not intended to limit the invention to the particular forms disclosed. For example, the particular implementation of the GUI may vary depending upon the particular type of computer system used. The software described in the foregoing were directed to networked cline/server implementations; however, similar techniques may be provided by other types of devices such as, but not limited to, televisions, gaming systems, teller machines and navigation systems. Implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A system comprising:
means for maintaining merchant information including merchant contact information, contests associated with merchants, and prize information;
means for maintaining participant information including participant contact information;
means for maintaining contact information;
means for conducting a scheduled contest for a merchant prize;
means for selecting a set of potential participants from said potential contest participant database to be notified of said scheduled contest;
means for notifying said set of potential participants of said scheduled contest;
means for presenting additional merchant offers to potential participants;
means for enabling a participant to invite others to participate in a contest;
means for selecting said merchant prize from said merchant database;
means for enabling a winner of said scheduled contest to invite one or more users to share in said merchant prize;
means for maintaining survey data from participants;
means for supporting third party contest components, third party contact databases, and third party notification components; and
a network over which the system communicates where merchants can promote contests to consumers via a networked application.

2. A system comprising:
a merchant database operable for maintaining merchant information including merchant contact information, contests associated with merchants, and prize information;
a potential contest participant database operable for maintaining participant information including participant contact information;
a contest component operable for conducting a scheduled contest for a merchant prize;
a first selection component operable for selecting a set of potential participants from said potential contest participant database to be notified of said scheduled contest;
a first notification component operable for notifying said set of potential participants of said scheduled contest;
a second selection component operable for selecting said merchant prize from said merchant database for said scheduled contest; and
a network over which said databases and said components communicate where merchants can promote contests to consumers via a networked application.

3. The system as recited in claim 2, further comprising a contact database operable for maintaining contact information including referring users.

4. The system as recited in claim 3, further comprising a second notification component operable for enabling a winner of said scheduled contest to invite one or more users selected from said contact database and said potential contest participant database to share in said merchant prize.

5. The system as recited in claim 2, further comprising a third notification component operable for enabling a participant to invite others to participate in a contest.

6. The system as recited in claim 2, further comprising a survey database operable for maintaining survey data from participants.

7. The system as recited in claim 2, further comprising an additional offers component operable for presenting additional merchant offers to potential participants.

8. The system as recited in claim 2, further comprising means for supporting third party contest components, third party contact databases, and third party notification components in which said third party includes social networking systems.

9. The system as recited in claim 2, in which a winner of said scheduled contest is selected at random.

10. The system as recited in claim 2, in which said scheduled contest is conducted at regularly occurring times.

11. The system as recited in claim 2, in which at least one notification component communicates with a mobile communications device.

12. The system recited in claim 2, in which the first selection component's selection is based at least in part on location and past contest participation.

13. The system recited in claim 2, in which the contest is an auction and the winner of said contest is the highest bidder.

14. The system as recited in claim 2, in which a winner of said scheduled contest is a game of skill.

15. A method comprising steps of:
transmitting, over a network to a server, merchant information including merchant contact information, contests, and prize information, said merchant information being maintained in a merchant database;
transmitting, over said network to a server, potential participant information including participant contact information, said potential participant information being maintained in a potential contest participant database; and
transmitting, over said network to a server, selection criteria where said selection criteria at least, in part, determines a set of potential participants from said potential contest participant database to be notified of a scheduled contest, said set of potential participants are notified of said scheduled contest, a contest component conducts said scheduled contest for a merchant prize and said merchant prize is selected from said merchant database, in which a merchant can promote contests to consumers via a networked application.

16. The method as recited in claim 15, further comprising the step of transmitting, over said network to a server, contacts to be maintained in a contacts database where a winner of said scheduled contest can invite one or more users selected from said contact database and said potential contest participant database to share in said merchant prize.

17. The method as recited in claim 16, further comprising the step of transmitting, over said network to a server, a limitation on a number of merchant prizes that can be shared.

18. The method as recited in claim 15, further comprising the step of transmitting, over said network to a server, offers to be presented to participants.

19. The method as recited in claim 15, further comprising the step of receiving, from a server, survey data collected from participants.

20. The method as recited in claim 15, in which said scheduled contest is conducted at regularly occurring times.

21. The method as recited in claim 15, in which a server communicates with a social networking system.

22. The method as recited in claim 15, in which a server communicates to a participant's mobile communication device.

23. The method as recited in claim 15, in which said set of potential participants are notified of multiple scheduled contests.
